(19) United States
(12) Patent Application Publication
(10) Pub. No.: US 2025/0051240 A1
(43) Pub. Date: Feb. 13, 2025

(54) USE OF A MINERAL COMPONENT, SAND, WOOD FLOUR OR COMBINATIONS THEREOF FOR REDUCING THERMAL CONDUCTIVITY OF A MINERAL FOAM

(71) Applicant: HOLCIM TECHNOLOGY LTD, ZUG (CH)

(72) Inventors: Florent DALAS, HOLDERBANK (CH); Cyril MOUNIE, HOLDERBANK (CH)

(21) Appl. No.: 18/720,490

(22) PCT Filed: Dec. 16, 2022
(86) PCT No.: PCT/EP2022/086470

§ 371 Date: Jun. 14, 2024

(30) Foreign Application Priority Data
Dec. 20, 2021 (EP) 21306862.0
Jun. 10, 2022 (EP) 22305853.8

(51) Int. Cl. C04B 38/10; C04B 14/28; C04B 28/04; C04B 111/40; C04B 111/92

(52) U.S. Cl. CPC C04B 38/10; C04B 14/28; C04B 28/04; C04B 2111/40; C04B 2111/92

(57) ABSTRACT

A method includes utilizing a component A selected from mineral component, sand, wood flour or combinations thereof, for reducing the thermal conductivity of a mineral foam, the mineral foam is produced by a process including contacting a cement slurry and a gas-forming liquid, the cement slurry includes a cement composition, ultrafine particles of which the D50 is from 10 to 600 nm, a transition metal salt and water, the cement composition including a Portland clinker and the component A, the gas-forming liquid includes a gas-forming agent.

### FIELD OF THE INVENTION

The present invention concerns a method for reducing the thermal conductivity of mineral foam.

### BACKGROUND OF THE INVENTION

Mineral foams are used in many technological applications. Due to their low thermal conductivity, good heat and fire resistance, and acoustic properties, this type of material is suitable for insulation applications in building construction and renovation.

A mineral foam is a concrete material in the form of foam. This material is generally more lightweight than typical concrete due to its pores or empty spaces. These pores or empty spaces are due to the presence of air in the mineral foam and they may be in the form of bubbles. An ultra-light foam is understood to be a foam generally having a density in its dry state of between 20 and 300 kg/m³.

Mineral foam can be produced by mixing two liquid components, i.e. a cement slurry and a liquid containing a gas-forming agent, to obtain a foaming slurry which expands to form a foamed slurry and then sets and hardens to become said mineral foam. The expansion is the direct consequence of the formation of bubbles upon mixing of the two liquids.

Mineral foam may collapse due to a lack of stability in the mineral foam before setting. These collapse problems of the foam may be due to coalescence phenomena, to Ostwald ripening phenomena, to hydrostatic pressure or to draining phenomena, the latter being greater in particular in case of elements of important height. The difficulty in the production of mineral foams is therefore to produce stable mineral foam which reduces these collapse problems. Examples of stable mineral foams are disclosed in the following applications: WO2016/102838, WO2019/092090.

Generally, a mineral foam is very advantageous for many applications due to its properties, such as its thermal insulation properties, its acoustic insulation properties, its durability, its resistance to fire and its easy implementation, especially compared to expanded polystyrene foams and other organic foams.

Reducing the thermal conductivity of mineral foam is essential for insulating materials. Reducing by only one milliwatt the thermal conductivity represents better insulation or less material thickness for the same insulation.

There is still a need for stable mineral foams having lower thermal conductivity, especially to be a viable alternative to expanded polystyrene foams, or other organic foams currently used.

### SUMMARY OF THE INVENTION

The invention is directed to the use of a component A selected from mineral component, sand, wood flour or combinations thereof, for reducing the thermal conductivity of a mineral foam. The mineral foam is produced by a process comprising a step of contacting a cement slurry and a gas-forming liquid. The cement slurry comprises a cement composition, ultrafine particles of which the D50 is comprised from 10 to 600 nm, a transition metal salt and water, the cement composition comprising Portland clinker and the component A. The gas-forming liquid comprises a gas-forming agent.

The mineral component is preferably selected from slag, pozzolanic materials, fly ash, calcined schists, material containing calcium carbonate for example limestone, silica fume, siliceous component, metakaolin and mixtures thereof.

Preferably, the sand is composed of particles that have a size greater than 0 mm to 2 mm, preferably greater than 0 mm to 0.5 mm.

Preferably, the wood flour is composed of wood particles that have a D50 comprised between 0.1 μm to 200 μm.

Preferably, the cement composition of the cement slurry comprises more than 25 wt.-%, preferably at least 30 wt.-%, more preferably at least 40 wt.-%, even more preferably at least 52 wt.-% of component A, compared to the total weight of the cement composition.

Component A preferably comprises material containing calcium carbonate, for example limestone, and at least one further component selected from sand, wood flour, a mineral addition different from material containing calcium carbonate, and combinations thereof.

Preferably, the cement composition of the cement slurry comprises 10 to 40 wt.-% of limestone, compared to the total weight of cement composition.

Preferably, the cement composition of the cement slurry comprises 10 to 30 wt.-% of limestone and from 20 to 60 wt.-% of slag, compared to the total weight of cement composition.

Preferably, the cement composition of the cement slurry comprises 21 to 30 wt.-% of limestone and from 5 to 10 wt.-% of silica fume, compared to the total weight of cement composition.

Preferably, the cement composition of the cement slurry comprises 10 to 30 wt.-% of limestone, from 20 to 60 wt.-% of slag, and from 5 to 10 wt.-% of silica fume, compared to the total weight of cement composition.

Preferably, the cement composition of the cement slurry comprises 10 to 30 wt.-% of limestone and from 20 to 40 wt.-% of sand, compared to the total weight of cement composition.

Preferably, the cement composition of the cement slurry comprises from 5 to 15 wt.-% of limestone and from 0.5 to 3 wt.-% of wood flour, compared to the total weight of cement composition.

In the cement slurry, water/cement mass ratio preferably ranges from 0.25 to 0.7, preferably from 0.28 to 0.6, more preferably from 0.29 to 0.45; mineral addition and/or sand and/or wood flour, ultrafine particles and cement are compatibilized as “cement” for the determination of water/cement mass ratio.

The mineral foam can be produced by a process comprising the following steps:
separately preparing a cement slurry and a gas-forming liquid, the cement slurry comprises a cement composition, ultrafine particles of which the D50 is comprised from 10 to 600 nm, a transition metal salt and water, the cement composition comprising Portland clinker and the component A, wherein the component A is as defined in any one of preceding claims;
contacting the cement slurry with a gas-forming liquid comprising a gas-forming agent to obtain a foamed cement slurry;
leaving the foamed cement slurry expanding to form the mineral foam.

Preferably, the dry mineral foam has a dry density ranging from 50 to 180 kg/m³, more preferentially from 50 to 170 kg/m³, even more preferentially from 80 to 130 kg/m³.

The dry mineral foam has preferably a thermal conductivity ranging:
from 0.03 to 0.07 W/m·K for dry density ranging from 50 to 180 kg/m³;
from 0.035 to 0.06 W/m·K for dry density ranging from 80 to 130 kg/m³.

The invention is also directed to a method for manufacturing a mineral foam comprising the following steps:
separately preparing a cement slurry as defined above and a gas-forming liquid;
contacting the cement slurry with a gas-forming liquid comprising a gas-forming agent to obtain a foamed cement slurry;
leaving the foamed cement slurry expanding to form the mineral foam.

### BRIEF DESCRIPTION OF THE DRAWINGS

The above and other objects, features and advantages of this invention will be apparent in the following detailed description of an illustrative embodiment thereof, with is to be read in connection with the accompanying drawing wherein:

FIG. 1 illustrates the thermal conductivity λ, at 10° C., in function of the dry density of the mineral foam for mineral foams RF1 to RF6 (●), IF1 (▪), IF2 (□), IF31 to IF 33 (x), IF4 (▴) and IF5 (cross with horizontal line in the middle), whose compositions are given in the examples.

### DEFINITIONS

Cement: cement is Portland cement. Portland cement comprises Portland clinker and usually calcium sulphate, and is preferably a Portland cement as defined in the standard NF-EN-197-1 of April 2012. The cements defined in standard NF-EN197-1 of April 2012 are grouped in 5 different families: CEM I, CEM II, CEM III, CEM IV and CEM V. In the present invention, the Portland cement is preferably chosen from the families CEM II, CEM III, CEM IV and CEM V. Alternatively, the Portland cement can be a CEM I, CEM II, CEM III, CEM IV or CEM V to which mineral components are added prior to preparing the cement slurry or during preparation of the cement slurry. The cement may optionally further contain less than 10 wt.-% of a calcium aluminate cement or a calcium sulfoaluminate cement, compared to the total weight of the cement, if shorter setting times and higher early age strength development are for example required.

Thus, when % are expressed in weight compared to the weight of cement, unless specified otherwise, the term cement includes the mineral component.

Calcium sulphate used according to the present invention includes gypsum (calcium sulphate dihydrate, CaSO₄·2H₂O), hemi-hydrate (CaSO₄·½H₂O), anhydrite (anhydrous calcium sulphate, CaSO₄) or a mixture thereof. Calcium sulphate produced as a by-product of certain industrial processes may also be used. Preferably, the calcium sulphate content ranges from 0% to 5% by weight of the cement, more preferably from 0.2% to 5% by weight of the cement composition.

Mineral component: The mineral component comprises one or at least one of the following components: slag (as defined in the European NF EN 197-1 Standard of April 2012, paragraph 5.2.2), pozzolanic materials (as defined in the European NF EN 197-1 Standard of April 2012, paragraph 5.2.3), fly ash (as described in the European NF EN 197-1 Standard of April 2012, paragraph 5.2.4), calcined schists (as described in the European NF EN 197-1 Standard of April 2012, paragraph 5.2.5), material containing calcium carbonate, for example limestone (as defined in the European NF EN 197-1 Standard paragraph 5.2.6), limestone components (as defined in the “Concrete” NF P 18-508 Standard), silica fume (as defined in the European NF EN 197-1 Standard of April 2012, paragraph 5.2.7), siliceous components (as defined in the “Concrete” NF P 18-509 Standard), ground steel slag, electric arc slag, metakaolin, or mixtures thereof.

Cement composition: composition comprising Portland clinker, calcium sulphate and a component A selected from mineral component, sand, wood flour or combinations thereof. When component A is mineral component, the cement composition is cement as defined above and the expression ‘cement’ and ‘cement composition’ can be used interchangeably.

Wood flour: powder made of ground wood particles

Cement slurry: The expression “cement slurry” designates a mixture comprising water and cement composition. That cement slurry may also comprise additional components, as disclosed below.

Gas-forming liquid: The expression “gas-forming liquid” designates a composition comprising a gas-forming agent. The gas-forming agent is preferably selected from hydrogen peroxide, peroxomonosulphuric acid, peroxodisulfphuric acid, alkaline peroxides, alkaline earth peroxides, organic peroxide, particles of aluminium, or mixtures thereof.

D50: The D50, also noted Dᵥ50, corresponds to the 50^{th} percentile of the volume distribution of the size of particles, that is to say that 50% of the volume is constituted of particles of which the size is less than the D50 and 50% of size greater than the D50. The D50 can be measured by a laser particle size method as further described below.

### DETAILED DESCRIPTION

It was discovered that substituting part of the Portland clinker with a mineral component, sand and/or a wood flour in a mineral foam reduces the thermal conductivity of the mineral foam. It has been discovered that at equal dry density of the mineral foam, thermal conductivity of the mineral foam decreases with increasing the substitution of Portland clinker with a mineral component and/or with sand and/or with wood flour. Surprisingly, the crystalline or amorphous nature of the mineral component and/or sand and/or wood flour has no or little effect on the thermal conductivity of the foam. On the contrary, increasing the amount of mineral component and/or sand and/or wood flour in the cement composition significatively impacts the thermal conductivity of the mineral foam.

The invention thus relates to the use of a component A selected from mineral component, sand, wood flour and combinations thereof, in a mineral foam comprising Portland clinker for reducing thermal conductivity of the mineral foam.

Specifically, the invention thus relates to the use of a component A, selected from mineral component, sand, wood flour and combinations thereof, in the cement composition used to prepare the cement slurry for reducing thermal conductivity of a mineral foam.

Specifically, the invention thus relates to the use of a component A selected from mineral component, sand, wood flour or combinations thereof, for reducing the thermal conductivity of a mineral foam by substituting part of Portland clinker with component A.

Specifically, the invention thus relates to the use of a component A selected from mineral component, sand, wood flour or combinations thereof, for reducing, at equal dry density of a mineral foam, the thermal conductivity of the mineral foam by substituting part of Portland clinker with component A.

The mineral foam is produced by a process comprising a step of contacting the cement slurry and a gas-forming liquid. The cement slurry comprises a cement composition, ultrafine particles of which the D50 is comprised from 10 to 600 nm, a transition metal salt and water, the cement composition comprising Portland clinker and the component A. The gas-forming liquid comprises a gas-forming agent.

In the invention, the cement composition comprises Portland clinker, component A and optionally calcium sulphate. The cement composition is used to prepare a cement slurry comprising water and the cement composition. The cement composition is preferably the sole source of cement used to prepare the cement slurry.

In the description of the cement composition, the percentages of Portland clinker, component A and other component such as calcium sulphate will be expressed in weight compared to the total weight of the cement composition, i.e. compared to the total weight of Portland clinker, component A and component such as calcium sulphate.

The invention also relates to a method for manufacturing a mineral foam comprising the following steps:
separately preparing a cement slurry and a gas-forming liquid, the cement slurry comprises a cement composition, ultrafine particles of which the D50 is comprised from 10 to 600 nm, a transition metal salt and water, the cement composition comprising Portland clinker and component A, wherein the component A is as defined in the following;
contacting the cement slurry with a gas-forming liquid comprising a gas-forming agent to obtain a foamed cement slurry;
leaving the foamed cement slurry expanding to form the mineral foam.

In the present invention, the component A, meaning mineral component and/or sand and/or wood flour, can be added to the cement composition prior or during the preparation of the cement slurry. Commercial cements, especially CEM III cements, can also be used.

Advantageously, the cement has a Blaine specific surface ranging from 3000 to 10000 cm²/g, preferably from 5000 to 8000 cm²/g.

The mineral component used according to the invention may be slag (for example, as defined in the European NF EN 197-1 Standard of April 2012, paragraph 5.2.2), pozzolanic materials (for example as defined in the European NF EN 197-1 Standard of April 2012, paragraph 5.2.3), fly ash (for example, as described in the European NF EN 197-1 Standard of April 2012, paragraph 5.2.4), calcined schists (for example, as described in the European NF EN 197-1 Standard of April 2012, paragraph 5.2.5), material containing calcium carbonate, for example limestone (for example, as defined in the European NF EN 197-1 Standard paragraph 5.2.6), limestone components (for example, as defined in the “Concrete” NF P 18-508 Standard), silica fume (for example, as defined in the European NF EN 197-1 Standard of April 2012, paragraph 5.2.7), siliceous components (for example, as defined in the “Concrete” NF P 18-509 Standard), metakaolin or mixtures thereof.

Examples of siliceous components are ground glass, solid or hollow glass beads, glass granules, expanded glass powder.

Fly ash is generally pulverulent particles comprised in fume from thermal power plants which are fed with coal. Fly ash is generally recovered by electrostatic or mechanical precipitation. Slag is generally obtained by rapid cooling of molten slag resulting from melting of iron ore in a furnace. Ground granulated blast furnace slag is generally used. Slag can also be obtained by electric arc furnaces, and such slags are a non-metallic by-product that consists mainly of silicates and oxides formed during the process of refining the molten steel. The feed materials for electric arc furnace slags are mainly steel scrap and pig iron.

Silica fume may be a material obtained by the reduction of very pure quality quartz by the coal in electric arc furnaces used for the production of silicon and alloys of ferrosilicon. Silica fume is generally formed of spherical particles comprising at least 85% by weight of amorphous silica.

The pozzolanic materials may be natural siliceous and/or silico-aluminous materials or a combination thereof. Among the pozzolanic materials, natural pozzolans can be mentioned, which are generally materials of volcanic origin or sedimentary rocks, and natural calcined pozzolans, which are materials of volcanic origin, clays, shale or thermally-activated sedimentary rocks.

Sand is preferably a siliceous sand or a siliceous-calcareous sand.

Sand is preferably composed of particles that have a size greater than 0 mm to 2 mm (noted 0/2), preferably greater than 0 mm to 0.5 mm (noted 0/0.5) or greater than 0 mm to 1.6 mm (noted 0/1.6).

Wood flour is advantageously composed of powdered wood particles that have a D50 generally comprised between 0.1 to 200 μm, preferably from 0.1 to 150 μm, more preferably from 1 μm and 100 μm.

All mineral components except silica fume are advantageously composed of particles that have a D50 generally comprised between 0.1 to 200 μm, preferably from 0.1 to 150 μm, more preferably from 1 μm and 100 μm.

Slag is preferably ground granulated blast furnace slag. Preferably, ground granulated blast furnace slag has a Blaine specific surface ranging from 2000 to 6000 cm²/g, preferably from 3000 to 5000 cm²/g.

Silica fume comprises particles that have a D50 between 0.05 and 100 μm, preferably between 0.05 and 1 μm.

Preferably, the cement composition of the cement slurry comprises more than 25 wt.-%, preferably at least 30 wt.-%, more preferably at least 40 wt.-%, even more preferably at least 52 wt.-% of component A, the percentages are expressed in weight compared to the total weight of cement composition.

Preferably, the cement composition of the cement slurry comprises up to 85 wt.-% of component A, advantageously up to 80 wt.-% of component A or up to 70 wt.-% of component A, the percentages are expressed in weight compared to the total weight of cement composition.

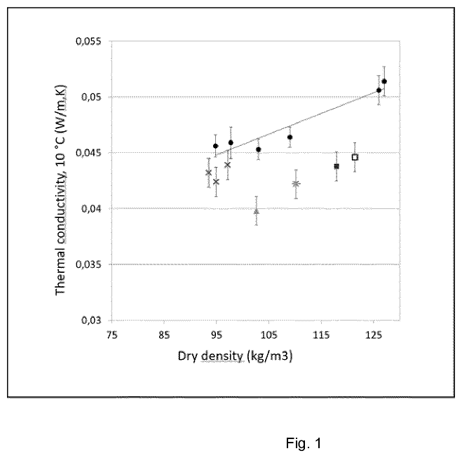

As shown in examples, especially in FIG. 1, the component A content will directly impact the thermal conductivity of the mineral foam for a given dry density.

Preferably, the component A comprises material containing calcium carbonate, for example limestone, and at least one further component selected from sand, wood flour, a mineral addition different from material containing calcium carbonate, and combinations thereof.

The cement composition of the cement slurry advantageously comprises 10 to 40 wt.-%, preferably 20 to 40 wt.-%, of material containing calcium carbonate, in particular limestone, compared to the total weight of cement composition.

Preferably the material containing calcium carbonate, for example limestone, is composed of particles that have a D50 generally comprised between 0.05 μm to 200 μm, preferably from 0.05 μm to 100 μm, more preferably from 0.1 μm to 10 μm.

Preferably, the component A is selected from mixtures of slag and limestone. The cement composition of the cement slurry advantageously comprises 10 to 30 wt.-% of limestone and at least 20 wt.-% of slag, preferably from 20 to 60 wt.-% of slag, compared to the total weight of cement composition.

Preferably, the component A is selected from mixtures of silica fume and limestone. The cement composition of the cement slurry advantageously comprises 21 to 30 wt.-% of limestone and at least 5 wt.-% of silica fume, preferably from 5 to 10 wt.-% of silica fume, compared to the total weight of cement composition.

Preferably, the component A is selected from mixtures of slag, silica fume and limestone. The cement composition of the cement slurry advantageously comprises 10 to 30 wt.-% of limestone, at least 20 wt.-% of slag, preferably from 20 to 60 wt.-% of slag, and at least 5 wt.-% of silica fume, preferably from 5 to 10 wt.-% of silica fume, compared to the total weight of cement composition.

Preferably, the component A is selected from mixtures of sand and limestone. The cement composition of the cement slurry advantageously comprises 10 to 30 wt.-% of limestone and at least 20 wt.-% of sand, preferably from 20 to 40 wt.-% of sand, preferably from 20 to 34 wt.-% of sand compared to the total weight of cement composition.

Preferably, the component A is selected from mixtures of sand, limestone and slag. The cement composition of the cement slurry advantageously comprises 10 to 30 wt.-% of limestone, at least 20 wt.-% of sand, preferably from 20 to 40 wt.-% of sand, preferably from 20 to 34 wt.-% of sand and at least 20% wt.-% of slag, preferably from 20 to 60 wt.-% of slag compared to the total weight of cement composition.

Preferably, the component A is selected from mixtures of wood flour and limestone.

The cement composition of the cement slurry advantageously comprises 0 to 15 wt.-% of limestone, preferably from 5 to 15 wt.-% of limestone, and at least 0.5 wt.-% of wood flour, preferably from 0.5 wt.-% to 10 wt.-% of wood flour, preferably from 0.5 wt.-% to 5 wt.-% of wood flour, preferably from 0.5 wt.-% to 3 wt.-%, preferably from 1 to 3 wt.-% of wood flour, compared to the total weight of cement composition.

Preferably, the component A is selected from mixtures of wood flour, limestone and slag.

The cement composition of the cement slurry advantageously comprises 0 to 15 wt.-% of limestone, preferably from 5 to 15 wt.-% of limestone, at least 0.5 wt.-% of wood flour, preferably from 0.5 wt.-% to 10 wt.-% of wood flour, preferably from 0.5 wt.-% to 5 wt.-% of wood flour, preferably from 0.5 wt.-% to 3 wt.-%, preferably from 1 to 3 wt.-% of wood flour, and at least 20% wt.-% of slag preferably from 20 to 60 wt.-% of slag compared to the total weight of cement composition.

The cement slurry will typically further comprise:
ultrafine particles of which the D50 is comprised from 10 to 600 nm;
a transition metal salt, preferably a manganese salt such as manganese chloride, MnCl₂;
optionally a water-reducing agent;
optionally fibres, in particular fibres having a length of 6 mm or 12 mm, and a diameter of 18 μm;
optionally a retarding agent, an accelerating agent, such as calcium chloride, or any other agent as defined in the standard NF EN 934-2 of September 2002; and
water.

The cement slurry does not comprise other cement or mineral addition than the components disclosed above in the description of the cement composition.

Advantageously, the cement slurry comprises from 0.5 to 10 wt. %, preferably from 1 to 7 wt. % of ultrafine particles compared to the total weight of cement slurry.

Advantageously, the ultrafine particles are as disclosed in WO2016/102838 or in WO2019/092090. In particular the ultrafine particles satisfy one or all of the following conditions:
the ultrafine particles have a liquid-solid contact angle comprised from 30° to 140°, preferably comprised from 40° to 130°, even more preferentially from 70° to 130°.
the ultrafine particles are partially rendered hydrophobic, for example by a stearic acid.
the ultrafine particles have a D50 preferably comprised from 20 to 500 nm, more preferentially comprised from 30 to 200 nm.
the ultrafine particles suitable are based one or more materials selected from calcareous powders, precipitated calcium carbonates, natural and artificial pozzolans, pumice stones, ground fly ashes, hydrated silica, in particular the products described in the document FR 2708592, and mixtures thereof.

It may be noted that the ultrafine particles generally comprise elementary particles having a diameter comprised from 10 to 50 nm. These elementary particles may agglomerate to form agglomerated particles having a diameter from 40 nm to 150 nm. These agglomerated particles may agglomerate to form aggregates having a diameter from 100 nm to 600 nm.

The water reducing agent is preferably a superplasticizer, such as PCP. The term “PCP” or “polyoxy polycarboxylate” is to be understood according to the present invention as a comb polymer comprising a backbone derived from acrylic acids and/or methacrylic acids bearing pending esters of polyoxyethylene (POE).

Preferably, the cement slurry of the present invention comprises from 0 to 2.0 wt. %, more preferentially from 0.05 to 1 wt. %, of a water reducing agent (dry content) compared to the total weight of the cement.

Preferably, the cement slurry does not comprise an anti-foaming agent, or any agent having the property of destabilizing an air/liquid emulsion. Certain commercial super-plasticisers may contain anti-foaming agents and consequently these super-plasticisers are not suitable for the cement slurry used to produce the mineral foam according to the invention.

Fibres can be polypropylene fibres.

Advantageously, the amount of fibres is between 0.2 wt. % and 2 wt. % by weight of cement, preferentially 0.2 wt. % and 1 wt. %.

The water/binder mass ratio of the cement slurry is preferably from 0.25 to 0.7, more preferably from 0.28 to 0.6, even more preferably from 0.29 to 0.45. The binder is composed of mineral addition and/or sand and/or wood flour, ultrafine particles and cement.

Advantageously, the mineral foam is produced by a process comprising the following steps:
separately preparing a cement slurry and a gas-forming liquid, the cement slurry comprises a cement composition, ultrafine particles of which the D50 is comprised from 10 to 600 nm, a transition metal salt and water, the cement composition comprising Portland clinker and the component A, wherein the component A is as defined above;
contacting the cement slurry with a gas-forming liquid comprising a gas-forming agent to obtain a foamed cement slurry;
leaving the foamed cement slurry expanding to form the mineral foam

Advantageously, the process is as disclosed in WO2016/102838 or in WO2019/092090 with further substitution of part of Portland clinker with component A.

In a preferred embodiment, the cement slurry is prepared by first blending a premix of cement, ultrafine particles and optionally component A. When component A comprises mineral addition, the mineral addition is preferably added to the premix. When component A comprises sand and/or wood flour, the sand and/or wood flour is added to the premix or later on when mixing premix and water. Preferably, the premix is constituted of all the solid constituents except the fibres of the cement slurry of the invention.

The cement slurry is then obtained by adding the premix to water comprising transition metal salt, and optionally water reducing agent. Component A, if not present in the premix, can be added during mixing. In particular, sand and/or wood flour can be added during mixing. Optionally fibres are subsequently added.

Advantageously, the gas-forming liquid is as disclosed in WO2016/102838 or in WO2019/092090. In particular the gas-forming liquid satisfy one or all of the following conditions:
the gas-forming agent is hydrogen peroxide, peroxomonosulphuric acid, peroxodisulfphuric acid, alkaline peroxides, alkaline earth peroxides, organic peroxide, particles of aluminium or mixtures thereof. Preferentially, the gas-forming agent is hydrogen peroxide.
it comprises viscosity modifying agent which is a polymer chosen among anionic bio-based polymer, amphiphilic bio-based polymer and alkali swellable acrylic polymer or mixture thereof. Preferably, the viscosity modifying agent is an amphiphilic polymer derived from cellulose, such as Methyl Cellulose, MethylHydroxyEthyl Cellulose, HydroxyPropylMethyl Cellulose and mixture thereof.

To achieve this desired density, the weight ratio between the cement slurry and the gas-forming liquid is adjusted as done for mineral foam based on CEM I. Surprisingly, for a same density, the thermal conductivity decreases when the content of mineral component increases, the mineral component replacing part of the Portland clinker.

Thermal conductivity (also known as lambda (λ)) is a physical magnitude characterizing the behavior of materials at the time of heat transfer via conduction. Thermal conductivity represents the amount of heat transferred per unit surface area and per unit of time under a temperature gradient. In the international unit system, thermal conductivity is expressed in watts per meter Kelvin (W·m⁻¹·K⁻¹).

The mineral foam obtained has preferably one or many of the following features:
The dry mineral foam has a dry density ranging from from 50 to 180 kg/m³, more preferentially from 50 to 170 kg/m³, even more preferentially from 80 to 130 kg/m³;
The dry mineral foam has a thermal conductivity ranging
   from 0.03 to 0.07 W/m·K for dry density ranging from 50 to 180 kg/m³;
   from 0.035 to 0.06 W/m·K for dry density ranging from 80 to 130 kg/m³.

The method has preferably one or more of the following characteristics:
the method is universal, which is to say it makes it possible to produce a stable mineral foam from any type of cement;
the method is easy to implement and to use at an industrial scale;
the method can be easily transported to any site;
the method makes it possible to implement a mineral foam in a continuous manner. It is therefore possible to produce the mineral foam continuously.

The mineral foam provided by the instant invention has preferably one or more of the following characteristics:
the mineral foam according to the invention has excellent stability properties. Notably the bubbles that compose the mineral foam in the fresh state are little degraded after pouring into the mould or depositing on a support;
the high stability of the mineral foam makes the preparation of lightweight mineral foams possible;
the mineral foam according to the invention has excellent thermal properties, and in particular very low thermal conductivity compared to known mineral foams having a similar dry density. It is highly desirable to reduce thermal conductivity in construction materials since this makes it possible to obtain savings of heating energy for residence and office buildings. Furthermore, this decrease makes it possible to reduce thermal bridges, in particular in the construction of buildings several stories high and designed using indoor thermal insulation. In particular thermal bridges are reduced on the intermediary floors.
the mineral foam has good mechanical properties, and notably good compressive strength. The mineral foam has preferably a compressive strength comprised from 0.04 to 5 MPa after 28 days, preferably from 0.05 to 2 MPa after 28 days, more preferentially from 0.05 to 1 MPa after 28 days.

Surprisingly, the quantity of Portland clinker is lowered but the mechanical resistance of the mineral foam does not sharply decrease.

The presence of mineral components makes it possible to obtain homogeneous, regular foam. The quantity of CSH (cement hydrates) decreases and the thermal conductivity is improved without degrading proportionally the other properties of the mineral foam: stability, mechanical strength, . . . .

The combined use of material containing calcium carbonate and at least another mineral component and/or sand and/or wood flour in a mineral foam is also new as such. Accordingly, the invention is also directed to mineral foam obtained by a process comprising a step of contacting a cement slurry and a gas-forming liquid, wherein:
the cement slurry comprises Portland clinker, ultrafine particles of which the D50 is comprised from 10 to 600 nm, a transition metal salt, water and from 10 to 30 wt.-% of material containing calcium carbonate and at least 20 wt.-% of component selected from pozzolanic materials, fly ash, slag, calcined schists, siliceous components, metakaolin, mixtures of silica fume with at least one of these mineral components, sand, wood flour and combinations thereof;
the gas-forming liquid comprises a gas-forming agent, preferably as defined above.

The mineral component, the sand, the wood flour and the material containing calcium carbonate, for example limestone, are as defined above and their content in the cement slurry are as defined above. When silica fume is present, its content is preferably less than 20 wt.-% compare to the total weight of the cement. The component can in particular be selected from slag, silica fume, sand, wood flour and combinations thereof. The cement slurry and the foamed cement slurry can further comprise the components disclosed above. The mineral foam provided by the instant invention has one or more of the characteristics described above.

The following examples illustrate the invention.

### Measurements

The measuring methods used are now detailed below.

### Method for Measuring a Wetting or Contact Angle:

The method disclosed in WO2019/092090 is implemented.

### Laser Granulometry Method

In this specification, including the accompanying claims, particle size distributions and particle sizes are as measured using a laser granulometer of the type Mastersize 2000 (year 2008, series MAL1020429) sold by the company Malvern.

Measurement is carried out in an appropriate medium (for example an aqueous medium for non-reactive particles, or alcohol for reactive material) in order to disperse the particles. The particle size shall be in the range of 1 μm to 2 mm. The light source consists of a red He—Ne laser (632 nm) and a blue diode (466 nm). The optical model is that of Frauenhofer and the calculation matrix is of the polydisperse type. A background noise measurement is effected with a pump speed of 2000 rpm, a stirrer speed of 800 rpm and a noise measurement for 10 s, in absence of ultrasound. It is verified that the luminous intensity of the laser is at least equal to 80% and that a decreasing exponential curve is obtained for the background noise. If this is not the case, the cell's lenses have to be cleaned.

Subsequently, a first measurement is performed on the sample with the following parameters: pump speed 2000 rpm and stirrer speed 800 rpm. The sample is introduced in order to establish an obscuration between 10 and 20%. After stabilisation of the obscuration, the measurement is carried out with a duration between the immersion and the measurement being fixed to 10 s. The duration of the measurement is 30 s (30000 analysed diffraction images). In the obtained granulogram one has to take into account that a portion of the powder may be agglomerated.

Subsequently, a second measurement is carried out (without emptying the receptacle) with ultrasound. The pump speed is set to 2500 rpm, the stirrer speed is set to 1000 rpm, the ultrasound is emitted at 100% (30 watts). This setting is maintained for 3 minutes, afterwards the initial settings are resumed: pump speed at 2000 rpm, stirrer speed at 800 rpm, no ultrasound. At the end of 10 s (for possible air bubbles to clear), a measurement is carried out for 30 s (30000 analysed images). This second measurement corresponds to a powder desagglomerated by an ultrasonic dispersion.

Each measurement is repeated at least twice to verify the stability of the result.

### Measurement of the Specific BLAINE Surface

The specific surface of the various materials is measured as follows. The Blaine method is used at a temperature of 20° C. with a relative humidity not exceeding 65%, wherein a Blaine apparatus Euromatest Sintco conforming to the European Standard EN 196-6 is used.

Prior to the measurement the humid samples are dried in a drying chamber to obtain a constant weight at a temperature of 50-150° C. The dried product is then ground in order to obtain a powder having a maximum particle size of less than or equal to 80 μm.

### Measurement of Thermal Conductivity

To measure thermal conductivity, two measuring devices are used: The CT-meter and the guarded hot plate.

Thermal conductivity was measured using a thermal conductivity measuring device: the CT-metre (Resistance 5Ω, probe wire 50 mm). The samples were dried in a drying oven at 45° C. until their weight remained constant. The sample was then cut into two equal pieces using a saw. The measurement probe was placed between the two flat sides of these two half samples (the sawed sides). Heat was transmitted from the source towards the thermocouple through the material surrounding the probe. The rise in temperature of the thermocouple was measured over time and the thermal conductivity of the sample was calculated.

Thermal conductivity was measured using a thermal conductivity measuring device: the guarded hot plate, TAURUS TLP 500 GX-1. The measurement has been validated for samples whose thermal conductivity is between 0.0295 and 0.6 W/(m·K) and whose compressive strength on the sample surface is greater than 200N. The samples were dried in a drying oven at 45° C. and 10% relative humidity, until their weight remained constant (difference less than 0.1 kg/m³/24 h)

The sample is placed between two contact plates containing the thermocouples and the cold faces and the hot faces are applied with a precharge of 125 N. For density less than 60 kg/m³ the preload is 62.5 N. The heat flux between hot plate and cold plate is measured at 10° C., 20° C. and 30° C. Thermal conductivity is calculated at 10° C. by linear regression from measurements at target average temperatures of 10° C., 20° C., 30° C.

### Examples

The cement used is selected from:
CEM I: Portland cement produced at Lafarge cement production site in Spain. It is a CEM I 52.5R Portland cement having a Blaine specific surface of 7710 cm²/g;
CEM II: Portland cement comprising silica fume produced at Holcim cement production site in Switzerland. It is a CEM II 52.5R Portland cement comprising 8 wt.-% of silica fume, compared to the total weight of the cement, and having a Blaine specific surface of 6310 cm²/g;
CEM III: Portland cement comprising slag fume produced at Lafarge cement production site in France. It is a CEM III 52.5L Portland cement comprising 36 wt.-% of slag, compared to the total weight of the cement, and having a Blaine specific surface of 4730 cm²/g;

The component A comprises:
Cassis sand: 0/1.6 sand produced in France (Cassis). The sand is calcareous.
Fulchiron sand: 0/0.315 sand produced in France (Fulchiron). The sand is siliceous.
BL200: ground limestone filler supplied by Omya under the brand name Betocarb, D50 is 6 μm.
SF: silica fume supplied by Rima. D50 is 0.4 μm.

### Ultrafine Particles:

Particles of precipitated calcium carbonate sold under the name Socal 312 and supplied by Imerys. These ultrafine particles have a contact angle varying from 90° to 130° as measured according to the method described above and a D50 of the particles of 40 nm as measured with the method described in the document EP1 740 649. These ultrafine particles are coated with stearine.
Transition metal salt: manganese salt; MnCl₂, 1 H₂O
Cement accelerator: CaCl₂)
Fibres: Fibres Ignis 6 mm D18 μm
Amphiphilic polymer: Walocel MKW 4000 PF supplied by Dow

The gas forming liquid is prepared by mixing the components of the table 1 into the respective proportions given in the table.

TABLE 1

| Components | Formulation (wt. %)* |
|---|---|
| H₂O₂ | 7.66 |
| Amphiphilic polymer | 0.035 |
| Water | 92.305 |

*the values are expressed as percentages in weight by total weight of gas forming liquid.

The following mineral foams have been prepared:

### REFERENCE

The cement slurry is prepared by mixing the components of the table 2 into the respective proportions given in the table.

TABLE 2

| Components | Formulation (wt. %)* |
|---|---|
| CEMI | 54.00 |
| BL200 | 16.79 |
| Ultrafine particles | 3.71 |
| Water-reducing agent | 0.33 |
| CaCl₂ | 0.10 |
| MnCl₂, 1H₂O | 0.77 |
| Fibres | 0.17 |
| Water | 24.12 |

*the values are expressed as percentages in weight by total weight of cement slurry.

The cement slurry of table 2 is mixed with the gas forming liquid of table 1, with different mass ratio depending on the targeted density.

Resulting foams have the following features:

TABLE 3

| | RF1 | RF2 | RF3 | RF4 | RF5 | RF6 |
|---|---|---|---|---|---|---|
| Dry density | 103 | 109 | 97.7 | 94.8 | 127 | 126 |
| (kg/m³) | | | | | | |
| Thermal | 0.0453 +/− | 0.0464 +/− | 0.0459 +/− | 0.0456 +/− | 0.0514 +/− | 0.0506 +/− |
| conductivity | 0.0009 | 0.0009 | 0.0014 | 0.001 | 0.0013 | 0.0013 |
| (W · m⁻¹ · K⁻¹) | | | | | | |

### Inventive Mineral Foam No. 1: With Cassis Sand in Addition to Limestone

The cement slurry is prepared by mixing the components of the table 4 into the respective proportions given in the table.

TABLE 4

| Components | Formulation (wt. %)* |
|---|---|
| CEMI | 38.58 |
| BL200 | 11.99 |
| Ultrafine particles | 2.66 |
| Cassis sand | 20.46 |
| Water-reducing agent | 0.34 |
| CaCl₂ | 0.07 |
| MnCl₂, 1H₂O | 0.78 |
| Fibres | 0.34 |
| Water | 24.77 |

*the values are expressed as percentages in weight by total weight of cement slurry.

The cement slurry of table 4 is mixed with the gas forming liquid of table 1, with different mass ratio depending on the targeted density.

Resulting foam has the following features:

TABLE 5

| | IF1 |
|---|---|
| Dry density (kg/m³) | 117.9 |
| Thermal conductivity (W · m⁻¹ · K⁻¹) | 0.0438 +/− 0.0013 |

### Inventive Mineral Foam No. 2: With Fulchiron Sand in Addition to Limestone

The cement slurry is prepared by mixing the components of the table 6 into the respective proportions given in the table.

TABLE 6

| Components | Formulation (wt. %)* |
|---|---|
| CEMI | 40.23 |
| BL200 | 12.50 |
| Ultrafine particles | 2.77 |
| Fulchiron sand | 21.34 |
| Water-reducing agent | 0.35 |
| CaCl₂ | 0.07 |
| MnCl₂, 1H₂O | 0.82 |
| Fibres | 0.36 |
| Water | 21.55 |

*the values are expressed as percentages in weight by total weight of cement slurry.

The cement slurry of table 6 is mixed with the gas forming liquid of table 1, with different mass ratio depending on the targeted density.

Resulting foam has the following features:

TABLE 7

| | IF2 |
|---|---|
| Dry density (kg/m³) | 121.4 |
| Thermal conductivity (W · m⁻¹ · K⁻¹) | 0.0446 +/− 0.0013 |

Inventive Mineral Foam No. 3; with Silica Fume in Addition to Limestone

The cement slurry is prepared by mixing the components of the table 8 into the respective proportions given in the table.

TABLE 8

| Components | Formulation (wt. %)* |
|---|---|
| CEMII | 56.30 |
| BL200 | 18.02 |
| Ultrafine particles | 4.00 |
| Water-reducing agent | 0.36 |
| CaCl₂ | 0.06 |
| MnCl₂, 1H₂O | 0.39 |
| Fibres | 0.18 |
| Water | 20.70 |

*the values are expressed as percentages in weight by total weight of cement slurry.

The cement slurry of table 8 is mixed with the gas forming liquid of table 1, with different mass ratio depending on the targeted density.

Resulting foams have the following features:

TABLE 9

| | IF31 | IF32 | IF33 |
|---|---|---|---|
| Dry density (kg/m³) | 94.9 | 93.5 | 97.1 |
| Thermal conductivity | 0.0424 +/− | 0.0432 +/− | 0.0439 +/− 0.0013 |
| (W · m⁻¹ · K⁻¹) | 0.0013 | 0.0013 | |

### Inventive Mineral Foam No. 4: With Slag in Addition to Limestone

The cement slurry is prepared by mixing the components of the table 10 into the respective proportions given in the table.

TABLE 10

| Components | Formulation (wt. %)* |
|---|---|
| CEMIII | 54.84 |
| BL200 | 16.84 |
| Ultrafine particles | 3.78 |
| Water-reducing agent | 1.23 |
| MnCl₂, 1H₂O | 0.51 |
| Fibres | 0.17 |
| Water | 22.63 |

*the values are expressed as percentages in weight by total weight of cement slurry.

The cement slurry of table 10 is mixed with the gas forming liquid of table 1, with different mass ratio depending on the targeted density.

Resulting foam has the following features:

TABLE 11

| | IF4 |
|---|---|
| Dry density (kg/m³) | 102.6 |
| Thermal conductivity (W · m⁻¹ · K⁻¹) | 0.0398 +/− 0.0013 |

### Inventive Mineral Foam No. 5: With Slag and Silica Fume in Addition to Limestone

The cement slurry is prepared by mixing the components of the table 12 into the respective proportions given in the table.

TABLE 12

| Components | Formulation (wt. %)* |
|---|---|
| CEMIII | 50.44 |
| BL200 | 16.84 |
| Ultrafine particles | 3.78 |
| Sllica fume | 4.38 |
| Water-reducing agent | 1.23 |
| MnCl₂, 1H₂O | 0.51 |
| Fibres | 0.17 |
| Water | 22.65 |

*the values are expressed as percentages in weight by total weight of cement slurry.

The cement slurry of table 12 is mixed with the gas forming liquid of table 1, with different mass ratio depending on the targeted density.

Resulting foam has the following features:

TABLE 13

| | IF5 |
|---|---|
| Dry density (kg/m³) | 110.2 |
| Thermal conductivity (W · m⁻¹ · K⁻¹) | 0.0422 +/− 0.0013 |

Thermal conductivity values of reference and inventive mineral foams in function of the dry density are reported on FIG. 1.

In FIG. 1, it can be seen that thermal conductivity, for a given dry density, is reduced when part of Portland clinker is replaced by component A.

1. A method comprising utilizing a component A selected from mineral component, sand, wood flour or combinations thereof, for reducing a thermal conductivity of a mineral foam,
the mineral foam is produced by a process comprising a step of contacting a cement slurry and a gas-forming liquid,
the cement slurry comprises a cement composition, ultrafine particles of which the D50 is comprised from 10 to 600 nm, a transition metal salt and water, the cement composition comprising Portland clinker and the component A,
the gas-forming liquid comprises a gas-forming agent.

2. The method according to claim 1, wherein the mineral component is selected from slag, pozzolanic materials, fly ash, calcined schists, material containing calcium carbonate, silica fume, siliceous component, metakaolin and mixtures thereof.

3. The method according to claim 1, wherein the sand is composed of particles that have a size greater than 0 mm to 2 mm.

4. The method according to claim 1, wherein the wood flour is composed of wood particles that have a D50 comprised between 0.1 μm to 200 μm.

5. The method according to claim 1, wherein the cement composition of the cement slurry comprises more than 25 wt.-% of component A, compared to the total weight of the cement composition.

6. The method according to claim 1, wherein component A comprises material containing calcium carbonate and at least one further component selected from sand, wood flour, a mineral addition different from material containing calcium carbonate, and combinations thereof.

7. The method according to claim 2, wherein the cement composition of the cement slurry comprises 10 to 40 wt.-% of a material containing calcium carbonate being limestone, compared to the total weight of cement composition.

8. The method according to claim 6, wherein the cement composition of the cement slurry comprises 10 to 30 wt.-% of a material containing calcium carbonate being limestone and from 20 to 60 wt.-% of slag, compared to the total weight of cement composition.

9. The method according to claim 6, wherein the cement composition of the cement slurry comprises 21 to 30 wt.-% of a material containing calcium carbonate being limestone and from 5 to 10 wt.-% of silica fume, compared to the total weight of cement composition.

10. The method according to claim 6, wherein the cement composition of the cement slurry comprises 10 to 30 wt.-% of a material containing calcium carbonate being limestone, from 20 to 60 wt.-% of slag, and from 5 to 10 wt.-% of silica fume, compared to the total weight of cement composition.

11. The method according to claim 6, wherein the cement composition of the cement slurry comprises 10 to 30 wt.-% of a material containing calcium carbonate being limestone and from 20 to 40 wt.-% of sand, compared to the total weight of cement composition.

12. The method according to claim 6, wherein the cement composition of the cement slurry comprises from 5 to 15 wt.-% of a material containing calcium carbonate being limestone and from 0.5 to 3 wt.-% of wood flour, compared to the total weight of cement composition.

13. The method according to claim 1, wherein in the cement slurry, water/cement mass ratio ranges from 0.25 to 0.7, mineral addition and/or sand and/or wood flour, ultrafine particles and cement being compatibilized as “cement” for determination of water/cement mass ratio.

14. The method according to claim 1, wherein the mineral foam is produced by a process comprising the following steps:
separately preparing a cement slurry and a gas-forming liquid, the cement slurry comprises a cement composition, ultrafine particles of which the D50 is comprised from 10 to 600 nm, a transition metal salt and water, the cement composition comprising Portland clinker and component A selected from mineral component, sand, wood flour or combinations thereof;
contacting the cement slurry with a gas-forming liquid comprising a gas-forming agent to obtain a foamed cement slurry;
leaving the foamed cement slurry expanding to form the mineral foam.

15. The method according to claim 1, wherein the mineral foam has a dry density ranging from 50 to 180 kg/m³.

16. The method according to claim 15, wherein the dry mineral foam has a thermal conductivity ranging:
from 0.03 to 0.07 W/m·K for dry density ranging from 50 to 180 kg/m³;
from 0.035 to 0.06 W/m·K for dry density ranging from 80 to 130 kg/m³.

17. A method for manufacturing a mineral foam comprising the following steps:
separately preparing a cement slurry as defined in claim 1 and a gas-forming liquid;
contacting the cement slurry with a gas-forming liquid comprising a gas-forming agent to obtain a foamed cement slurry;
leaving the foamed cement slurry expanding to form the mineral foam.

18. The method according to claim 5, wherein the cement composition of the cement slurry comprises at least 52 wt.-% of component A, compared to the total weight of the cement composition.

19. The method according to claim 13, wherein in the cement slurry, water/cement mass ratio ranges from 0.29 to 0.45.

20. The method according to claim 15, wherein the mineral foam has a dry density ranging from 80 to 130 kg/m³.
